(19) United States
(12) Patent Application Publication
(10) Pub. No.: US 2008/0246893 A1
(43) Pub. Date: Oct. 9, 2008

(54) Internal light masking in projection systems

(76) Inventors: Gregory Jensen Boss, American Fork, UT (US); Yen-Fu Chen, Austin, TX (US); Rick Allen Hamilton, Charlottesville, VA (US); Kevin C. McConnell, Austin, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 12/157,247

(22) Filed: Jun. 9, 2008

Related U.S. Application Data
(63) Continuation of application No. 11/249,934, filed on Oct. 13, 2005.

(51) Int. Cl. H04N 9/31

(52) U.S. Cl. 348/744; 348/E09.025

(57) ABSTRACT

A system and method is provided for masking traditional grey bars which are produced by displaying wide screen images within a full screen native projector and visa versa. This method allows blocking of light for unused portions of the screen thereby producing higher contrast images. In an exemplary embodiment, a physical shutter is positioned inside the projection system so that the light which would otherwise produce a grey bar area is blocked before it reaches a projection screen. Image data are analyzed to identify grey screen areas which are not being utilized for image display and light which would otherwise produce such grey areas is blocked or shuttered by the projector to eliminate the grey areas.

### FIELD OF THE INVENTION

The present invention relates generally to information processing systems and more particularly to a system and methodology for eliminating grey border areas of projected images.

### BACKGROUND OF THE INVENTION

There are two basic screen resolutions in media and video. Full screen resolution images are generally considered to be in an aspect ratio of width to height of 4:3 respectively. This full screen resolution has been around for many decades and is probably still the most prevalent. However a wide screen resolution with dimensions of 16:9 is becoming more and more popular for media and video. It is reasonable to assume that both formats will continue and this is true for the screen dimension aspect ratio seen on computer using audio/video players. Consumers currently have a choice of buying, renting, downloading, and purchasing videos, movies, and television systems which are sold in both wide screen and full screen formats.

One problem created by having dual or multiple formats is that televisions and projection systems have a fixed resolution which is either wide-screen or full screen. This means that if a television or projection device tries to display and image other than the native aspect ratio, there will be created a pair of grey bars. If for instance a wide screen projector displays a full screen image, the 4:3 image placed in a 16:9 physical device will produce two vertical grey bars that become unused portions of the screen. Similarly if a 16:9 image is displayed on a 4:3 device then two horizontal grey bars are produced in the top and bottom portions of the physical screen.

Today all projectors necessarily exhibit this behavior because of the way charge-coupled devices (CCDs) are created, implemented, and utilized. A charge-coupled device is a light-sensitive integrated circuit that stores and displays the data for an image in such a way that each pixel (picture element) in the image is converted into an electrical charge, the intensity of which is related to a color in the color spectrum. Grey bars are so called because there is some portion of light that is creating them, yet they are intended to be black because no data is being sent to those portions of the screen. Black is the preferred color because having a black border around a video or movie image produces a perceived effect of higher contrast. Higher contrast is one of the most important elements to producing a good quality image (resolution and color depth/saturation are the others). In each case, manual solutions are described to help overcome the problems inherent in differing video formats.

In movie theaters everywhere designers typically place black curtains around the projected image. Generally there are several versions of wide screen images displayed at theaters. Some are wide screen, some anamorphic wide screen, and other variants. Since the screen is generally a shade of white the theater will close the curtains to surround the edge of the projected image. This usually includes moving curtains from the right and left closer to the screen and can sometimes also include moving a top curtain down towards the top edge of the screen. Home theater enthusiasts will also employ this technique. Then, the grey bars are covered by the black curtains. Solutions which exist today to eliminate the grey bar problem are not satisfactory, and each involves manually masking light upon the projection screen/surface.

Thus, there is a need for an improved methodology and system for eliminating grey border areas of projected images.

### SUMMARY OF THE INVENTION

A system and method is provided for masking traditional grey bars which are produced by displaying wide screen images within a full screen native projector and visa versa. This method allows blocking of light for unused portions of the screen thereby producing higher contrast images. In an exemplary embodiment, a physical shutter is positioned inside the projection system so that the light which would otherwise produce a grey bar area is blocked before it reaches a projection screen. Image data are analyzed to identify grey screen areas which are not being utilized for image display and light which would otherwise produce such grey areas is blocked or shuttered by the projector to eliminate the grey areas.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of an exemplary video projection system in which the present invention may be implemented;

FIG. 2 is an illustration of a 16:9 ratio projector showing a 4:3 ratio image;

FIG. 3 is an illustration of a 4:3 ratio projector showing a 16:9 ratio image;

FIG. 4 is a schematic diagram illustrating an exemplary embodiment of the present invention;

FIG. 5 is an exemplary screen display of a 4:3 ratio projected image using the present invention;

FIG. 6 is an exemplary screen display of a 16:9 ratio projected image using the present invention; and

FIG. 7 is a flow chart illustrating an operational sequence in an exemplary operation of the present invention.

### DETAILED DESCRIPTION

It is noted that circuits and devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention.

This system and method involves implementing a physical shutter inside the projection system so that the light comprising the grey bar area produced is blocked before it reaches the screen. Further, it involves a method for determining which areas of the screen should be internally masked by analyzing the signals for each of the pixels in the image aggregated at a row level.

A projector which has these functions will monitor the image data and look for entire rows of data which contain no image information, or contain the same pure “black” signal throughout the entire row. This will indicate a portion of the physical screen which is not being utilized, likely due to a scenario of displaying 16:9 aspect images on a 4:3 physical aspect screen or visa versa. The methodology may be implemented as a software plug-in for media players to automatically detect and adjust borders to ensure optimal contrast by blocking unused area so audience only sees the screen and no grey bars. Upon detection of straight black pixels, this invention's software module can calculate the spacing that the grey bars are taking up and leveraging the space available to expand the area to the maximum. Essentially this module can trigger the media player to automatically size the borders to block the grey bars creating the “no border” effect for the viewers. This will produce images which do not get washed out by the appearance of grey bars and prevent the need for complicated screen adjustments.

An exemplary embodiment includes an implementation of a physical shutter inside a projector, a monitor to analyze pixel content signals in real-time and a method to interpret grey bar area based on monitored pixel content signals.

The implementation of this invention involves placing opaque mechanical plate in at least two opposite sides, and possible all for sides of the light path before it reaches the lens. These plates are motorized with precision enough to cover the exact number of pixels in the horizontal or vertical axis so as to prevent the grey light from projecting onto the projection surface. The plates are controlled by the circuitry that is already on board (or added if it doesn't exist) that monitors the size and ratio of the incoming signal (analog or digital).

Today there are generally two prevalent video formats used in film and they are described by a ratio of width to height. The two formats are then wide-screen or 16:9 and full screen or 4:3. Due to the nature of CRT, LCD, DLP and other projection technologies, the ratio of any TV or projection system is fixed so that when a format other than that which is native to the projection system is used one of several things must be done. The image can be scaled and/or stretched to match the native resolution and ratio which causes distortion and is generally considered unacceptable. Alternatively, the image can be scaled down so that its ratio fits within the destination projectors limits. This causes grey bands to appear at the top if going from 16:9 to 4:3 or, in the more common method, on the side if going from 4:3 to 16:9. Grey bands (often called black bars) are a problem because grey bars detract significantly from the perceived contrast ratio of a given image. This is why all professional theaters and many home theaters have curtains that will adjust horizontally and/or vertically to match the exact size/ratio of the output image. These curtains then are always deep black.

There are however a significant portion of people with TV's or projection systems that do not have curtains for one reason or another. For those people, the view experience is degraded significantly because the projection system always creates these grey bars with the mechanism in the projection system that produces black. Projection systems though cannot produce blacks that are equivalent to a matte black material which can be painted or applied otherwise and this is due to the fact that bright bulbs are often used to project additive black (Red plus Green plus Blue for example). The bulb projecting the image is often 500 to over 2000 ANSI lumens and this has the effect of washing out the black and making it appear to be greyer.

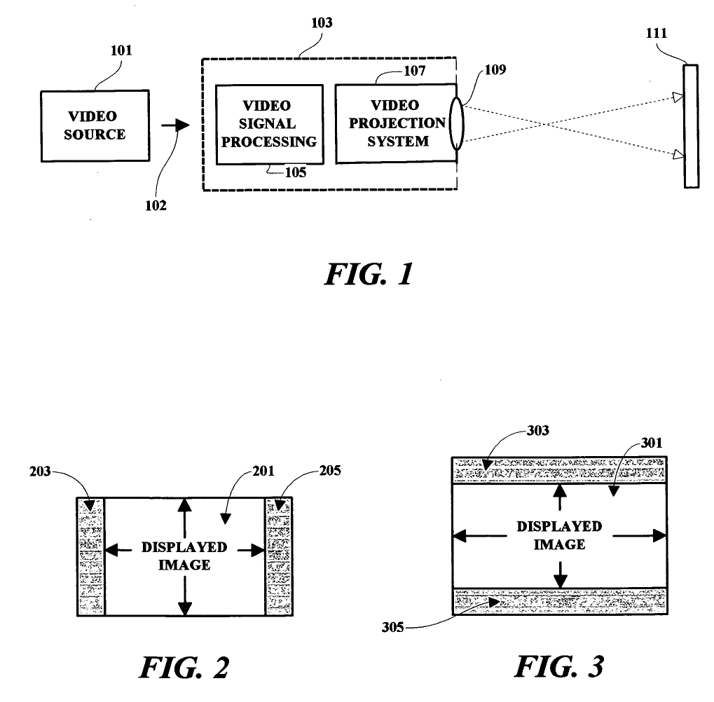

In FIG. 1, there is shown an exemplary projection system in which a video stream or image is sent 102 from a video source 101 and received by a video display system 103. The video display system 103 includes a video signal processor 105 for processing the input video signals and a video projection system 107 for projecting video images through a lens system 109 to a display screen 111.

In FIG. 2, grey bars 203 and 205 appear when a 4:3 ratio displayed image 201 is shown projected from a 16:9 ratio projection system.

In FIG. 3, grey bars 303 and 305 appear when a 16:9 ratio displayed image 201 is shown projected from a 4:3 ratio projection system.

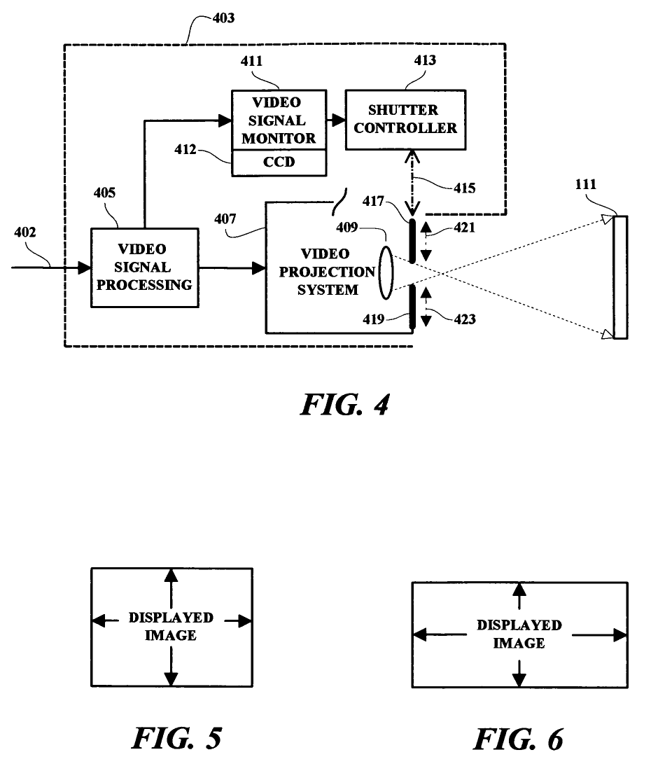

FIG. 4 illustrates an exemplary embodiment of a video projection system which eliminates the grey bars shown in FIG. 2 and FIG. 3. As shown, a video projection system 403 receives an input 402 which includes video signals which are applied to a video signal processing circuit 405. The processed video signals are then applied to a projection system 407 for projecting an image or a video stream of images through a lens system 409 to a display screen 111. The system also includes a video signal monitor circuit 411 and a CCD device 412. The CCD device stores a charge representative of the color of each pixel in an image to be projected. The video signal monitor circuitry is operable to monitor the video signal to analyze pixel colors as stored in the CCD device 412 and provide shutter control signals to a shutter controller 413 to block grey areas which would otherwise be projected.

The video signal is monitored to identify pixels that fall within a certain range of grey/black, or, depending upon the source signal, monitor for pixels that contain no information. Such monitoring is accomplished in accordance with certain predetermined rules, including but not limited to: (1) monitoring all pixels (as determined by the signal intensity stored in a CCD element corresponding to a given pixel) of the same color comprising more than a predetermined percentage of the screen; (2) monitoring all pixels of the same color (shade of grey) that also comprise a rectangle of any proportion; (3) monitoring all pixels of the same color over a period of time; (4) monitoring all pixels that contain no color information; and/or (5) the masked area can only begin with an outer row or column of pixels and extend inwardly until one of the above conditions is broken. The above rules and others may be implemented as a process in a group or in a preferred combination, and may be manufacturer or user configurable, in order to determine which areas of a projected image get blocked out. Optionally, a user could manually enter the source video dimensions (e.g. 4:3 or 16:9) and the system would adjust the projected image accordingly.

As noted above, the shutter controller 413 operates 415 to effect movement 421 and 423 of shutter elements 417 and 419 in order to eliminate vertically displaced grey bar areas (e.g. 303 and 305) that would otherwise be produced when a first ratio image is projected from a second ratio projector system. Shutter elements may also be implemented, alone or in combination with shutters 417 and 419, in a direction orthogonal to that shown in FIG. 4, in order to eliminate horizontally displaced grey bars (e.g. 203 and 205). As a result of implementing the video display system of FIG. 4, the grey bars that would otherwise have been produced are eliminated and a 4:3 ratio image projected from a 16:9 ratio projector would display as shown in FIG. 5, while a 16:9 ratio image projected from a 4:3 ratio projector would display as shown in FIG. 6.

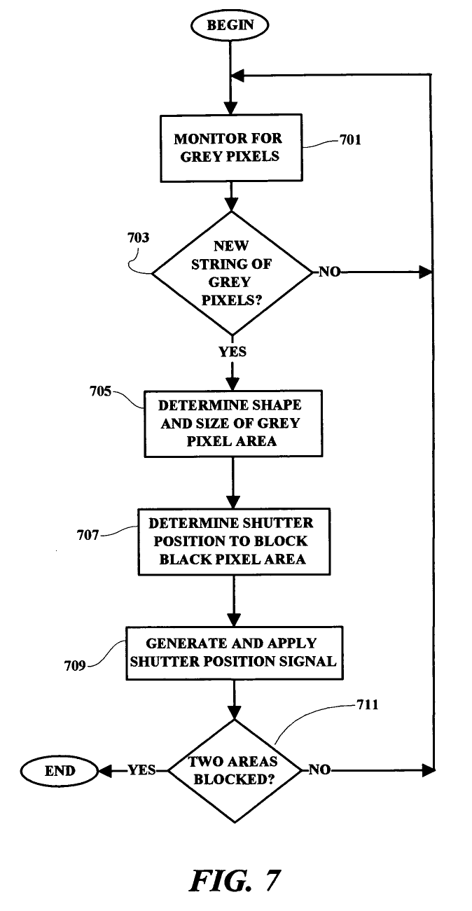

In FIG. 7, there is shown a flow chart illustrating an exemplary operational sequence in an exemplary implementation of the present invention. As shown, the video system is effective to monitor 701 a video signal for grey pixel content, and when a new string of grey pixel content is detected 703, the size and shape of the pixel content grey bar area is determined 705. Next, the shutter positions required to block the light which would otherwise cause the appearance of the grey bars is determined 707 and appropriate signals are generated and applied 709 to a shutter mechanism. The shutters then move to a position which is effective to block light which would otherwise cause the appearance of vertically displaced or horizontally displaced grey bars. The physical shutter starts the analysis in a fully open position. The physical shutter then moves inwardly, one pixel at a time, and analyzes pixel types. The system will continue to monitor for the grey bars on an opposite side of a projected image, and the shutter control process is repeated until two grey bar areas have been detected and blocked 711 at which time the process ends and the projection shutters remain in place during the entirety of the projected video presentation.

The method and apparatus of the present invention has been described in connection with a preferred embodiment as disclosed herein. The present invention may be implemented in many different combinations of hardware and software. The disclosed methodology may be implemented in a wide range of sequences to accomplish the desired results as herein illustrated. Although an embodiment of the present invention has been shown and described in detail herein, along with certain variants thereof, many other varied embodiments and combinations that incorporate the teachings of the invention may be easily constructed by those skilled in the art, and, at least in part, even included or integrated into a processor or CPU or other larger system integrated circuit or chip. The disclosed methodology may also be implemented partially in program code stored on a CD, disk or diskette (portable or fixed), or other memory medium or device, from which it may be loaded or transmitted to a memory device and executed to achieve the beneficial results as described herein. Accordingly, the present invention is not intended to be limited to the specific form set forth herein. On the contrary, it is intended to cover such alternatives, modifications, and equivalents, as can be reasonably included within the spirit and scope of the invention.

What is claimed is:

1. A method for projecting light to provide projected images having a first aspect ratio, said projected images being projected along a light path prior to exiting a projection device, said projection system being designed to project images having a second aspect ratio different from said first aspect ratio, said method comprising:
providing a light-blocking device in said light path;
determining that said projected images have said second aspect ratio; and
adjusting a position of said light blocking device to block portions of projected light which are not a part of said projected images from exiting said projection device.

2. The method as set forth in claim 1 wherein said first aspect ratio comprises a 16/9 ratio.

3. The method as set forth in claim 1 wherein said first aspect ratio comprises a 4/3 ratio.

4. The method as set forth in claim 1 wherein said second aspect ratio comprises a 4/3 ratio.

5. The method as set forth in claim 1 wherein said second aspect ratio comprises a 16/9 ratio.

6. The method as set forth in claim 1 wherein said determining is accomplished by monitoring pixel content of said projected images.

7. The method as set forth in claim 6 wherein said adjusting of said light blocking device is accomplished in response to a detection of video signal content representative of a series of identical grey pixels.

8. The method as set forth in claim 1 wherein said projected images comprise a series of discretely projected images.

9. The method as set forth in claim 1 wherein said projected images comprise a continuous video stream of images.

10. A projection system for projecting light to provide projected images having a first aspect ratio, said projected images being projected along a light path prior to exiting a projection device, said projection system comprising:
a projection device for receiving a video signal and projecting light in response to said video signal along said light path to provide said projected images, said projection device being designed to project images having a second aspect ratio different from said first aspect ratio;
a light-blocking device in said light path;
signal processing means for processing an input video source signal to provide said video signal to said projection device;
means for determining that said projected images have said second aspect ratio; and
means for adjusting a position of said light blocking device when said projected images are determined to have said second aspect ratio to block portions of projected light which are not a part of said projected images from exiting said projection device.

11. The projection system as set forth in claim 10 wherein said first aspect ratio comprises a 16/9 ratio.

12. The projection system as set forth in claim 10 wherein said first aspect ratio comprises a 4/3 ratio.

13. The projection system as set forth in claim 10 wherein said second aspect ratio comprises a 4/3 ratio.

14. The projection system as set forth in claim 10 wherein said second aspect ratio comprises a 16/9 ratio.

15. The projection system as set forth in claim 10 wherein said determining is accomplished by monitoring pixel content of said projected images.

16. The projection system as set forth in claim 15 wherein said adjusting of said light blocking device is accomplished in response to a detection of a series of video signal content representative of a series of identical grey pixels.

17. The projection system as set forth in claim 10 wherein said projected images comprise a series of discretely projected images.

18. The projection system as set forth in claim 10 wherein said projected images comprise a continuous video stream of images.
